(19) United States
(12) Patent Application Publication
(10) Pub. No.: US 2012/0290462 A1
(43) Pub. Date: Nov. 15, 2012

(54) METHOD AND SYSTEM FOR REGULATORY STRUCTURE PRODUCTS

(75) Inventor: Rajan Mehta, Mumbai (IN)

(73) Assignee: BRAINWORKS ODYSSEY PRIVATE LIMITED, Mumbai, Maharashtra (IN)

(21) Appl. No.: 13/514,018

(22) PCT Filed: Nov. 11, 2010
(86) PCT No.: PCT/IN2010/000736

§ 371 Date: Jun. 5, 2012

(30) Foreign Application Priority Data
Feb. 3, 2010 (IN) 287/MUM/2010

(51) Int. Cl. G06Q 40/04

(52) U.S. Cl. 705/37

(57) ABSTRACT

Accordingly it is a principle object of the present invention to overcome the disadvantages and limitations of prior art methods and systems and provide a method and system for trading exchange traded products constituted in accordance with the principles of the present invention which will be a regularity structure, wherein Paired/Split mutual fund units may be created out of the same structure which is open ended. It is yet another object of the present invention to achieve zero sum nature for the paired unit and provide simultaneous issuance/redemption of all classes on units/shares for payoff.

### BACKGROUND

A. Technical Field

The present invention relates to an automated method and system for trading exchange traded products with payoff structure designated through the benchmarks that are publically available and undisputed standard figure.

B. Background of the Invention

Generally, the most common professionally managed type of collective investment schemes are mutual fund and exchange traded funds. These schemes pools money from many investors and invest it in stocks, bonds, short-term money market instruments, and/or other securities.

The mutual fund will have a fund manager that trades the pooled money on a regular basis. The net proceeds or losses are then typically distributed to the investors annually. Mutual funds can invest in many kinds of securities. The most common are cash instruments, stock, and bonds, but there are hundreds of sub-categories. Stock funds, for instance, can invest primarily in the shares of a particular industry, such as technology or utilities. These are known as sector funds. Bond funds can vary according to risk, type of issuers, or maturity of the bonds. Most mutual funds' investment portfolios are continually adjusted and administered under the supervision of fund managers.

The net asset value, or NAV, is the current market value of a fund's holdings, less the fund's liabilities, usually expressed as a per-share amount. For most funds, the NAV is determined daily, after the close of trading on some specified financial exchange. The public offering price, or POP, is the NAV plus a sales charge. Open-end funds sell shares at the POP and redeem shares at the NAV, and hence process the orders only after the NAV is determined. Closed-end funds may trade at a higher or lower price than their NAV; this is known as a premium or discount, respectively. If a fund is divided into multiple classes of shares, each class will typically have its own NAV, reflecting differences in fees and expenses paid by the different classes.

Turnover is a measure of the fund's securities transactions, usually calculated over a year's time, and usually expressed as a percentage of net asset value. The term mutual fund being open-ended means that, at the end of every day, the fund issues new shares to investors and buys back shares from investors wishing to leave the fund. A front-end load or sales charge is a commission paid to a broker by a mutual fund when shares are purchased, taken as a percentage of funds invested. The value of the investment is reduced by the amount of the load. Some funds have a deferred sales charge or back-end load.

The exchange-traded fund or ETF, having been in existence for a while, Exchange Traded Funds (ETFs) have never quite captured the investor's imagination. An ETF is a basket of securities that is traded on the stock exchange, akin to a stock. So, ETFs are listed on a recognized stock exchange. Their units can be bought and sold directly on the exchange, through a stockbroker during the trading hours. ETFs can be either close-ended or open-ended. Open-ended ETFs can issue fresh units to investors even post the new fund offer stage, although this tends to happen selectively on account of the substantial lot sizes involved. In case of ETFs, since the buying and selling is largely done over the stock exchange, there is minimal interaction between investors and the fund house.

Further, ETFs are generally passively managed. It attempts to replicate the performance of a designated benchmark index. Hence it invests in the same stocks, which comprise its benchmark index and in the same weightage. For example, Nifty BeES is a passively managed ETF with the S&P CNX Nifty being its designated benchmark index. In the Indian context, passively managed ETFs are more prominent.

Investors often confuse ETFs with conventional mutual funds. The only similarity between ETFs and conventional mutual funds is that they both provide investors an opportunity to invest in an assortment of stocks/instruments through a single avenue.

An investor in a mutual fund needs to buy and sell units from the fund house. In case of an ETF, the transaction has to be routed through a broker as buying and selling is done on the stock exchange. In the rare case that an investor can buy or redeem units in an ETF through the fund house, it is normally done in a pre-defined lot size. Typically, the lot size tends to be substantial making it feasible only for institutional investors and high networth individuals (HNIs).

Since ETFs are traded on the stock exchange, they can be bought and sold at any time during market hours like a stock. This is known as ‘real time pricing’ as ETF investors can transact at the price prevailing at that point in time. This is in contrast to mutual funds, wherein units can be bought and redeemed only at the relevant NAV; the NAV is declared only once at the end of the day. As a result, ETF investors have the opportunity to make the most of intra-day volatility. Of course, this may hold little significance for long-term investors.

ETFs are associated with low expenses vis-à-vis mutual funds. A passively managed ETF which tracks a benchmark index would have an annual recurring expense less compared to an index fund tracking the same benchmark index. Unlike mutual fund entry/exit loads, ETF investors do not have to bear any loads. ETFs safeguard the interests of long-term investors. In case of mutual funds, the possibility of a substantial redemption adversely affecting the fund cannot be ruled out. While mutual funds are always available at end-of-day NAV, ETFs do not necessarily trade at the NAV of their underlying portfolio.

ETFs have a few minor disadvantages. Unlike open-ended mutual funds, ETFs cannot reinvest dividends. Dividends are paid out to owners of shares at the end of each quarter. This has a slightly adverse effect on performance and is called “dividend drag.” Prices of ETF trades are based on market forces, so a buyer might buy at a slight premium or discount. This difference between .the price of an ETF and the price of the underlying net asset value is usually very small. When it drifts, arbitrageurs will step in and make a profit bringing the price back to net asset value.

While investors have to incur entry/exit loads at the time of making/redeeming investments in mutual funds, for ETFs they have to pay a brokerage. Brokerage commissions can seriously erode ETFs' low-expense advantage, especially when investing small sums of money. Also, ETFs are capitalization weighted, similar to the indexes on which they are based. Since ETF track a particular sector or index, associative Index fund disadvantages are also observed by the investors while investing in ETF.

The derivatives markets are the financial markets for derivatives, financial instruments like futures contracts or options, which are derived from other forms of assets. The market can be divided into two, that for exchange traded derivatives and that for over-the-counter derivatives. The legal nature of these products is very different as well as the way they are traded, though many market participants are active in both.

Over-the-counter (OTC) derivatives are very common way of exchanging various types payoffs based on different Benchmarks. Also there are exchange traded derivatives and exchange traded notes/certificates to fulfill the same function. OTC derivatives and Notes and certificates have counterparty risk and exchange traded derivatives have mark to market margin risk. Also many investors may not have legal approval to trade in derivatives and hence they can not use exchange traded derivatives. Currently these anomalies are to an extent mitigated by issuing paired/Split units Mutual Fund/Unit Trust structure in following ways

1. Close ended split Mutual Fund

This is one of the common ways to gain leverage on the portfolio and leverage is provided by market. Also it has been used to give principal protected payoffs

The problem with them is that number of units can not be increased or decreased during their tenure as they are closed ended.

One of the major drawbacks of this structure is lack of liquidity and erratic pricing in secondary market.

2. Paired units issued by two distinct trusts with agreement to swap cash flows based on defined benchmark indicator.

Such structure requires complex income sharing agreements between two trusts with quarterly flows.

The disadvantage for such structures is that such income sharing agreements may not be legal in all jurisdictions and also in the interim the trading happens at dirty prices, which may create some confusion for investors.

For the reasons stated above, which will become apparent to those skilled in the art upon reading and understanding the specification, there is a need in the art for an automated method and system for analyzing the parametric testing data captured over a time sequence.

### SUMMARY OF THE INVENTION

A method and system for creating Paired/Split mutual fund units out of same Mutual Fund scheme/Units Trust scheme, collective investment scheme and investment trust scheme/company which is open ended trading and investment. The method and system provide simultaneous issuance/redemption of all classes of units/shares for pay offs, wherein the resultant paired units achieve the zero sum nature. The issuance of units, deliver returns linked to various investible and non investible benchmarks without investing them and/or regular distribution of income through increase in number of units and setting up defined maturity with varied option and provide flexibility to trade each class of units as different securities either on exchange or on OTC basis.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

The above and other objects, features and advantages of the present invention will be more clearly understood from the following detailed description taken in conjunction with the accompanying drawings, in which:

FIG. 1 shows a system for trading exchange traded products as per one embodiment herein.

FIG. 2 illustrates a flowchart for a system for trading exchange traded products as per an embodiment of present invention.

### DETAILED DESCRIPTION OF THE DRAWINGS

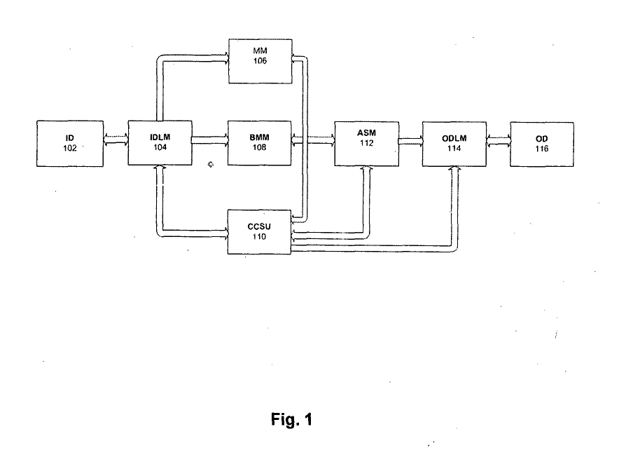

The FIG. 1 defines the method and system for trading exchange traded products as per an embodiment of present invention. The modules confining the system may carry associative functions of the method for trading exchange traded products.

The Input device referred as “ID” (102), receive the parameters from the external user as inputs which are the parameters used to set the benchmark.

The Input device link module referred as “IDLM” (104), through controlled operations by Central Control and Synchronization Unit referred as “CCSU” (110), synchronizes and links the input device to the memory module (106), Benchmark Module (108),

The Benchmark Module referred as “BMM” (108), determines a bench mark by processing, analyzing and linking various input parameters received from the input device

The Memory Module referred as “MM” (106), is a storage medium which stores and/or actively/passively updates the total database consisting of various classes of units/shares data.

The Central Control and Synchronization Unit referred as “CCSU” (110), which synchronize and control operations of all the modules constituting the system.

The Arbitration-Selection Module referred as “ASM” (112), setup maturity & relationship between the various class of units and/or shares with the

Benchmark, in order that the resultant paired unit achieves zero-sum nature and provide simultaneous issuance/redemption of all classes of units/shares for pay offs.

The output device link module referred as “ODLM” (114), through controlled operations by Central Control and Synchronization Unit (110), synchronizes and links the output device to the Arbitration-Selection Module (112).

The Output device referred as “OD” (116), provide the processed output to the user

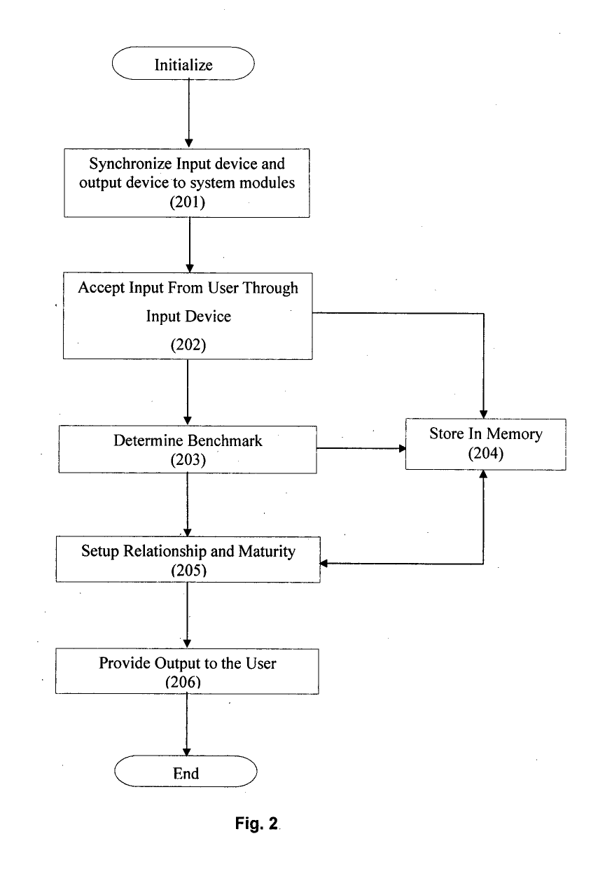

The FIG. 2 illustrates a flowchart for a system for trading exchange traded products as per an embodiment of present invention.

The system start its functioning by synchronizing and linking the input device and output device (201).

The system receives inputs at 202 which may comprise many individual variables. These variables may convey parameters for determining benchmark. These inputs are stored at memory (204).

Further the received inputs are fed to generate benchmarks (203). These benchmarks are stored at memory (204).

The benchmarks are then mapped to setup maturity & relationship (205) between the various class of units and/or shares with the Benchmark, in order that the resultant paired unit achieves zero-sum nature and provide simultaneous issuance/redemption of all classes of units/shares for pay offs.

Then the, processed output is presented to the user (206).

### DETAILED DESCRIPTION OF THE INVENTION

The embodiments herein provide a method and system for trading and investment. Further the embodiments can be easily implemented in various regulatory structures like Mutual Fund/Unit Trust/Trust/company etc. The method of the invention can also be implemented as application performed by a stand alone or embedded system.

The invention described herein is explained using specific exemplary details for better understanding. However, the invention disclosed can be worked on by a person skilled in the art without the use of these specific details.

References in the specification to “ one embodiment” or “ an embodiment” means that a particular feature, structure, characteristic, or function described in connection with the embodiment is included in at lest one embodiment of the invention. The appearances of the phrase “in one embodiment” in various places in the specification are not necessarily all referring to the same embodiment.

The words “comprises/comprising”, “generates/providing”, “performing” and the words “having/including” when used herein with reference to the present invention are used to specify the presence of stated features, integers, steps or components but does not preclude the presence or addition of one or more other features, integers, steps, components or groups thereof.

Hereinafter, the preferred embodiments of the present invention will be described in detail with reference to the accompanying drawings. Reference now should be made to the drawings, in which the same reference numerals are used throughout the different drawings to designate the same or similar components. For clear description of the present invention, known constructions and functions will be omitted.

Parts of the description may be presented in terms of operations performed by a computer system, using terms such as data, state, link, fault, packet, and the like, consistent with the manner commonly employed by those skilled in the art to convey the substance of their work to others skilled in the art. As is well understood by those skilled in the art, these quantities take the form of data stored/transferred in the form of electrical, magnetic, or optical signals capable of being stored, transferred, combined, and otherwise manipulated through mechanical and electrical components of the computer system; and the term computer system includes general purpose as well as special purpose data processing machines, switches, and the like, that are standalone, adjunct or embedded.

As per one of the embodiment of the present invention, the defined system will be only one regulatory structure, where in the Paired/Split mutual fund units may be created out of the same structure which is open ended.

Further, issuing such units deliver returns linked to various investible and non investible benchmarks without investing into them. Further, such units provide very liquid and transparent investment vehicles which may give exposure to various asset classes.

The system for trading exchange traded products as per an embodiment of present invention comprise of :a Input device referred as “ID” (102), a Input device link module referred as “IDLM” (104), The Benchmark Module referred as “BMM” (108), The Memory Module referred as “MM” (106), The Central Control and Synchronization Unit referred as “CCSU” (110), The Arbitration-Selection Module referred as “ASM” (112), The output device link module referred as “ODLM”(114), The Output device referred as “OD” (116). The modules confining the system may carry associative functions of the method for trading exchange traded products.

As per one of the embodiment of the present invention, the Input device “ID” (102) of the defined system, receive the parameters from the external user as inputs which are the parameters used to set the benchmark.

As per one of the embodiment of the present invention, the Input device link module “IDLM” (104) of the defined system, through controlled operations by Central Control and Synchronization Unit referred as “CCSU” (110), synchronizes and links the input device to the memory module (106) and Benchmark Module (108),

As per one of the embodiment of the present invention, the Benchmark Module “BMM” (108) of the defined system, determines a bench mark by processing, analyzing and linking various input parameters received from the input device

As per one of the embodiment of the present invention, the Memory Module “MM” (106) of the defined system is a storage medium which stores and/or actively/passively updates the total database consisting of various classes of units/shares data.

As per one of the embodiment of the present invention, the Central Control and Synchronization Unit “CCSU” (110) of the defined system, which synchronize and control operations of all the modules constituting the system.

As per one of the embodiment of the present invention, the Arbitration-Selection Module “ASM” (112) of the defined system, setup maturity & relationship between the various class of units and/or shares with the Benchmark, in order that the resultant paired unit achieves zero-sum nature and provide simultaneous issuance/redemption of all classes of units/shares for pay offs. As per one of the embodiment of the present invention, the output device link module “ODLM”(114) of the defined system, through controlled operations by Central Control and Synchronization Unit (110), synchronizes and links the output device to the Arbitration-Selection Module (112).

As per one of the embodiment of the present invention, the Output device “OD” (116) of the defined system, provide the processed output to the user

As per one of the embodiment of the present invention, the defined system may consist of a database consisting of different classes of units/shares. The system issues two kinds of units i. e. (i) Bear Units and (ii) Bull units, which will be listed separately on the Stock Exchange. The system issues paired/split units by setting a relation ship through the arbitration-selection module where in the arbitration-selection module setup relationship between the different classes of units which are linked to external Benchmark. The Benchmark is be set through analyzing and linking various inputs such as Equity Index, Single of multiple equity shares, Any arithmetical relationship between stocks and stocks, indices and indices or stocks and indices, Commodity, basket of commodities, commodity indices, weather indices, credit events, interest rates, currency or basket of currency, real estate indices, or any other variable whose value can be derived in objective and non disputable manner. Further, the number of such units issued may increase or decrease. There is definite relationship between a set of all classes of the units/shares so that they will achieve zero sum nature, where in their sum total may be always 2× though the pair may be defined as equal or unequal.

In one embodiment of the system, the present invention may have defined maturity with option of early close out and further optionally have rollover option.

In one embodiment of the system, the present invention provides simultaneous issuance/redemption of all classes of units/shares. Further, there will be regular distribution of income through increase in number of units.

The method for issuing paired/split units shall setup relationship between the different classes of units linked to external Benchmark which can include Equity Index, Single of multiple equity shares, Any arithmetical relationship between stocks and stocks, indices and indices or stocks and indices, Commodity, basket of commodities, commodity indices, weather indices, credit events, interest rates, currency or basket of currency, real estate indices, or any other variable whose value can be derived in objective and non disputable manner.

The issuance and redemption of the units is done at NAV based prices.

NAV calculations for the Bull Units and Bear Units:

The NAV for the Bull Unit and Bear Unit will be calculated separately in the following way.

NAV for Bull Unit=Base NAV+index adjustment

NAV for Bear Unit=Base NAV−Index adjustment

Where

$$Base NAV ( Rs . ) = \frac{\begin{matrix}Market or Fair Value of {Scheme}^{′} s investment + \\ Current Assets minus Current Liabilities and \\ Provision ( including accrued expenses )\end{matrix}}{\begin{matrix}No . of Bull Units and Bear Units outstanding \\ under Scheme on the Valuation Date\end{matrix}} .$$

Index adjustment=2×100×(Final Index Level−Initial Index Level)/initial Index Level

Maximum Index Adjustment=+100 Rs. Or Base NAV whichever is lower

Minimum Index Adjustment=−100 Rs. Or (−Base NAV) whichever is higher

The example for calculation of NAV of Bear Units and Bull Units based on the movement of S&P CNX Nifty on a day to day basis is as follows with the

Initial Index level being 5000:

| | | | Index Ad- | | Bull | Bear |
|---|---|---|---|---|---|---|
| | | %% [symbol] | justment | Base | Unit | Unit |
| Dates | Index | Change | Rs | NAV | NAV | NAV |
| 1/4/2010 | 5000 | 0 | 0 | | 100 | 100 |
| 2/4/2010 | 5100 | 2.0% | 4 | 100.01 | 104.01 | 96.01 |
| 3/4/2010 | 4900 | −2.0% | −4 | 100.03 | 96.03 | 104.03 |
| 4/4/2010 | 4850 | −3.0% | −6 | 100.04 | 94.04 | 106.04 |
| 5/4/2010 | 4950 | −1.0% | −2 | 100.06 | 98.06 | 102.06 |
| 6/4/2010 | 4800 | −4.0(″″ [symbol] | −8 | 100.07 | 92.07 | 108.07 |
| 7/4/2010 | 5000 | 0.0% | 0 | 100.08 | 100.08 | 100.08 |
| 8/4/2010 | 5200 | 4.0° 0 | 8 | 100.1 | 108.1 | 92.1 |
| 9/4/2010 | 50.50 | 1.0% | 2 | 100.12 | 102.12 | 98.12 |
| 10/4/2010 | 4850 | −3.0% | −6 | 100.13 | 94.13 | 106.13 |
| 11/4/2010 | 4600 | −8.0″″′ [symbol] | −16 | 100.1.5 | 84.1.5 | 116.15 |

[symbol]

indicates data missing or illegible when filed

The method for issuing paired/split units issues units with exactly opposite payoffs. The payoffs are zero sum attribute payoff such that their some total may be always ‘2x’. The pair may be defined equal or unequal. The equal pair shall have value of each unit as ‘x’ resulting into sum total as 2x wherein the unequal pair will have one unit having fractional divisional value of x and the other may having fractional multiple value of x such that their sum total may always be 2x.

The method for issuing paired/split units shall setup the benchmark for the pay of such that it may be publicly available and may be undisputable standard figure. It may be linked to any benchmark like equity shares/Indices, Fixed Income Papers/Basket of Papers/Indices, Currency, Currency indices, Commodity/Commodity indices, Real Estate/real Estate indices, Weather, Outcome of event (like sporting event, election etc.), Credit Default Index, Swap Index/Rate, Yield Curve Spreads/Index, etc. but not limited to them.

The method for issuing paired/split units provide linear payoff, linear leveraged payoff or non linear payoff linked to the Benchmark.

The example for pay offs designed like linear payoff, linear leveraged payoff or non linear payoff may be illustrated as below by considering the Benchmark as S&P CNX Nifty

Case 1. Linear Payoff

Final Bull Units Payoff=((Final Index level−Initial Index Level)/Initial Index Level)*100+Principal Value

Final Bear Unit Payoff=Combined (Bull+Bear) Principal Value−Final Bull Unit Payoff

Case 2. Leveraged Linear Payoff

Final Bull Units Payoff=2×((Final Index level−Initial Index Level)/Initial Index Level)*100+Principal Value

Final Bear Unit Payoff=Combined (Bull+Bear) Principal Value−Final Bull Unit Payoff

Case 3. Non Linear Payoff

Final Bull Units Payoff=Min [0, ((Final Index level−Initial Index Level)/Initial Index Level)*100]+Principal Value

Final Bear Unit Payoff=Combined (Bull+Bear) Principal Value−Final Bull Unit Payoff

The method for issuing paired/split units shall setup defined maturity with option of early close out and further may have rollover option. Each issue of paired units may have defined maturity and also a standard early maturity clause which specifies that at the end of the trading day, if the notional value of one of the paired units is equal to or less than zero than the trading may be stopped immediately from the next day. Immediately the entire portfolio will be liquidated and the proceeds will be paid out to the investors appearing on register as on record date which may be at least one day after the settlement date for the last trading day.

The method for issuing paired/split units provide flexibility to trade each class of units as different securities either on exchange or on OTC basis. The method for issuing paired/split units have operational capability to measure daily entitlement of distribution.

Further, the system reduces the need for two separate trusts with payout agreement with each other. Also the units can be designed with daily dividend/daily bonus option on prorate basis which removes need for inter, say income distribution.

The defined system can be used to introduce many exchange traded products, which allows investors to gain exposures in many underlying asset classes in very transparent and well-defined manner with liquidity.

The defined method and system structure have potential to meet regulatory requirements for an investment trust/unit trust/mutual fund in many jurisdictions across the world. The structure is extremely simple and easier from risk monitoring perspective. This structure can be also designed as an omnibus vehicle for various underlying.

1. A system for creating Paired/Split mutual fund units out of same Mutual Fund scheme/Units Trust scheme which is open ended trading and investment comprising:
Input device link module (IDLM) for synchronizing and linking the input device;
One or more input devices (ID) to input the parameters to set benchmark;
A benchmark module (BMM) for determining a bench mark by processing, analyzing and linking various input parameters received from the input device;
A memory module (MM) for storing and/or actively/passively updating the said total database consisting of various classes of units/shares data on a storage medium;
Arbitration-selection module (ASM) for setting up maturity & relationship between the various class of units and/or shares with the Benchmark, in order that the resultant paired unit achieves zero-sum nature and provide simultaneous issuance/redemption of all classes of units/shares for pay offs, wherein issuance of units and/or redemption deliver returns linked to various investible and non investible benchmarks without investing them and/or regular distribution of income through increase in the number of units and for setting up defined maturity;
Output device link module (ODLM) for synchronizing and linking the output device;
Central control and synchronization unit (CCSU) for synchronizing and controlling operations of all the modules constituting the system;
One or more output devices (OD) to output the processed data.

2. The system according to claim 1, wherein said input device link module synchronizes and links the system to input device.

3. The system according to claim 1, wherein said input device is a keyboard and/or another computer and/or cell phone and/or personal digital device.

4. The system according to claim 1, wherein said output device link module synchronizes and links the system to output device.

5. The system according to claim 1, wherein said output device is a Display device and/or printer.

6. The system according to claim 1, wherein the Benchmark module is a processor.

7. The system according to claim 1, wherein input data is comprise of various inputs such as Equity Index, Single of multiple equity shares, Any arithmetical relationship between stocks and stocks, indices and indices or stocks and indices, Commodity, basket of commodities, commodity indices, weather indices, credit events, interest rates, currency or basket of currency, real estate indices and/or other variable whose value can be derived in objective and non disputable manner is captured and set through analysis and linking to link it to the units/shares of various class data from the storage device.

8. The system according to claim 1, wherein a data storage device storing and/or actively/passively updating the said total database consisting of various classes of units and/or shares data on the storage medium

9. The system according to claim 6, wherein said storage medium is a hard drive and for floppy disc and for CD ROM disc and for thumb drive.

10. The system according to claim 1, wherein the arbitration-selection module is a processor having arbitration logic implemented for setting up relationship between the various class of units/shares which are linked to Benchmark for achieving zero sum nature and provide simultaneous issuance/redemption of all classes of units/shares for pay offs, wherein issuing units deliver returns linked to various investible and non investible benchmarks without investing them and/or regular distribution of income through increase in number of units.

11. The system according to claim 1, where in the system provide options for setting up defined maturity such as early close out option and rollover option.

12. The system according to claim 1, wherein the arbitration-selection module defines pay off which can be linear payoff, linear leveraged payoff, nonlinear payoff.

13. The system according to claim 1, wherein the arbitration-selection module designs units with pay off, such as periodic dividend/periodic bonus/no dividend option.

14. A method for creating Paired/Split mutual fund units out of same Mutual Fund scheme/Units Trust scheme, collective investment scheme and investment trust scheme/company which is open ended trading and investment comprising steps of:
Synchronizing and linking the input device for receiving inputs;
Receiving the parameter inputs for determining benchmark;
Determining the bench mark by processing, analyzing, and linking various parameter inputs received from input device;
setting up relationship between the various class of units/shares with the benchmark in order that the resultant paired unit achieve zero sum nature and provide simultaneous issuance/redemption of all classes of units/shares for pay offs, wherein issuing units delivers returns linked to various investible and non investible benchmarks without investing them and/or regular distribution of income through increase in number of units and setting up defined maturity with varied option through the arbitration-selection module; and provide flexibility to trade each class of units as different securities either on exchange or on OTC basis;
Synchronizing and linking the output device to output the processed data output.

15. The method of claim 14, wherein the step of receiving inputs, receives various inputs such as Equity Index, Fixed incentive index, Single or Multi basket final incentive index, Single or multiple equity shares, relationship between stocks and stocks, indices and indices or stocks and indices, Commodity, basket of commodities, commodity indices, weather indices, credit events, interest rates, currency or basket of currency, real estate indices, or any other variable.

16. The method of claim 14, wherein the step of setting up Benchmark, sets the benchmark through processing, analyzing and linking various inputs.

17. The method of claim 14, wherein the step of arbitration and selection, sets relationship between the various classes of units/shares with the Benchmark.

18. The method of claim 14, wherein the step of arbitration and selection, sets relationship between the various class of units/shares with the Benchmark in order that the resultant paired unit achieve zero sum nature and provide simultaneous issuance/redemption of all classes of units/shares for pay offs.

19. The method of claim 14, wherein the step of arbitration and selection, sets relationship between the various class of units/shares with the Benchmark, wherein issuing units delivers returns linked to various investible and non investible benchmarks.

20. The method of claim 14, wherein regular distribution of income is through increase in number of units.

21. The method of claim 14, wherein the defined maturity can be set through with option of early close out and rollover option.

22. The method of claim 14, issues units with exactly opposite payoffs wherein the payoffs are zero sum attribute payoff such that their sum total may be always ‘2x’ and the pair may be defined equal or unequal.

23. The method of claim 14 provides linear payoff, linear, leveraged payoff or non linear payoff linked to the Benchmark.

24. The method of claim 14, have flexibility to trade each class of units as different securities either on exchange or on OTC basis.

25. The method of claim 14, have operational capability to measure daily entitlement of distribution.

26. The method of claim 14, optionally designs units with periodic dividend/periodic bonus option on prorate basis.
